(19) United States
(12) Patent Application Publication
(10) Pub. No.: US 2025/0085995 A1
(43) Pub. Date: Mar. 13, 2025

(54) WEIGHT-BASED DISTRIBUTION FOR CONSISTENT HASHING ALGORITHM

(71) Applicant: Citrix Systems, Inc., Fort Lauderdale, FL (US)

(72) Inventors: Vemula Srimithra, Bangalore (IN); Aman Chaudhary, Bangalore (IN); Vidhi Agrawal, Bangalore (IN); Lakshmi Prasanna Guru, Bangalore (IN)

(21) Appl. No.: 18/462,492

(22) Filed: Sep. 7, 2023

(51) Int. Cl. G06F 9/455; H04L 67/60

(52) U.S. Cl. CPC G06F 9/45558; H04L 67/60; G06F 2009/45595

(57) ABSTRACT

Systems and methods for weight-based distribution for consistent hashing algorithm are provided. A system can include one or more processors, coupled with memory. The one or more processors can maintain a table of a count of replicas of each of a plurality of services that is generated based on a weight of each of the plurality of services. The one or more processors can receive, from a client device remote from the one or more processors, a request. The one or more processors can select, from the table based on the request, a service of the plurality of services. The one or more processors can route the request to the selected service of the plurality of services.

### FIELD OF THE DISCLOSURE

This application generally relates to data communication networks, including but not limited to systems and methods for weight-based distribution for consistent hashing algorithm.

### BACKGROUND

A client device can initiate a request to transmit data or obtain resources to or from one or more remote servers. To establish a communication channel or a path with at least one of the servers, a load balancer can receive the request from the client device and direct the request to an available server. The load balancer can direct traffic from the client device to the server for handling the requests from the client.

### BRIEF SUMMARY

Client devices can transmit requests to an intermediary device, such as an application delivery controller (“ADC”), for distributing traffic or requests across different remote servers or services within a computing environment. As applications are increasingly executing or being hosted on servers in a cloud computing environment (e.g., a server farm or data center), it can be challenging for the ADC to adapt to the increase in dynamic application workloads as servers automatically scale to adjust the amount of computational resources allocated to process the traffic or requests in the server farm. The servers in the computing environment can be deployed using a stateless mesh architecture, which can achieve 99.9999% reliability, for example. The ADC can use a consistent hash algorithm as a method for distributing traffic to the servers deployed with stateless architectures. The ADC can use the consistent hash algorithm to achieve both fault tolerance and uniform load distribution. However, in deployment scenarios in which the ADC manages a disproportionate load, or the servers in the server farm have heterogeneous capacities or resource utilization costs, it can be challenging for the consistent hashing algorithm to account for load balancing multiple points of presence (POPs) (e.g., servers or services). For example, the different services or servers can be configured with different capacities or capabilities in regard to their storage or computing power, or divert different amounts of traffic to various sites according to the service rate structure (e.g., pricing or cost) or region affinity, among other factors.

This technical solution can provide mechanisms or techniques to factor in weights to consistent hashing algorithms. The weights can be based on the capability or capacity (e.g., processing power or storage) of the servers receiving requests from the client devices. For example, a relatively higher weight (e.g., a higher number) can be assigned to servers with relatively higher capacity and a relatively lower weight (e.g., a lower number) can be assigned to servers with relatively lower capacity. The systems and methods can generate a number or count of replicas of the servers according to at least the weight associated with the servers. By replicating the server instance, the systems and methods can manage (or cater) requests to the disproportionate load, thereby improving the distribution of resources or demand, minimizing resource consumption, and avoiding server overload.

In an aspect, this technical solution can be directed to a system. The system can include one or more processors, coupled with memory. The one or more processors can maintain a table of a count of replicas of each of a plurality of services that is generated based on a weight of each of the plurality of services. The one or more processors can receive, from a client device remote from the one or more processors, a request. The one or more processors can select, from the table based on the request, a service of the plurality of services. The one or more processors can route the request to the selected service of the plurality of services.

The one or more processors can determine a first count of replicas for a first service of the plurality of services based on a first weight of the first service. The one or more processors can determine a second count of replicas for a second service of the plurality of services based on a second weight of the second service. The first count of replicas can be greater than the second count of replicas and the first weight is greater than the second weight. The first service can have a greater processing capacity compared to the second service.

The plurality of services can comprise a plurality of servers. The plurality of services can comprise a plurality of virtual machines hosted in a cloud computing environment.

The one or more processors can generate a first service hash based on application of a hash function to a tuple formed from an IP address and a port of a first service of the plurality of services. The one or more processors can generate a plurality of replicas based on combining the first service hash with one or more prime numbers selected from a prime number array. The one or more processors can store the plurality of replicas in the table to route requests to access the first service.

The one or more processors can determine a first count of replicas to generate based on a replication factor for the first service. The one or more processors can generate the plurality of replicas with the first count of replicas.

The one or more processors can determine a first count of replicas to generate based on a replication factor for the first service and a first weight of the first service. The one or more processors can generate the plurality of replicas with the first count of replicas.

The one or more processors can generate a first service hash based on application of a hash function to a tuple formed for a first service of the plurality of services. The one or more processors can generate a plurality of replicas based on application of the hash function or a second hash function to the first service hash combined with a second one or more values selected from an array. The one or more processors can store the plurality of replicas in the table to route requests to access the first service.

The one or more processors can determine that a first service of the plurality of services is unavailable. The one or more processors can remove or disable replicas in the table generated for the first service to cause subsequent requests for the first service to be routed to a different service of the plurality of services. The one or more processors can determine subsequent to the removal, that the first service is available. The one or more processors can update the table to include or enable the replicas generated for the first service to maintain a consistent mapping of client devices to the plurality of services.

In an aspect, this technical solution can be directed to a method. The method can include maintaining, by one or more processors coupled with memory, a table of a count of replicas of each of a plurality of services that is generated based on a weight of each of the plurality of services. The method can include receiving, by the one or more processors, a request from a client device remote from the one or more processors. The method can include selecting, by the one or more processors, from the table based on the request, a service of the plurality of services. The method can include routing, by the one or more processors, the request to the selected service of the plurality of services.

The method can include determining, by the one or more processors, a first count of replicas for a first service of the plurality of services based on a first weight of the first service. The method can include determining, by the one or more processors, a second count of replicas for a second service of the plurality of services based on a second weight of the second service. The first count of replicas can be greater than the second count of replicas and the first weight is greater than the second weight.

The first service can have a greater processing capacity compared to the second service. The method can include generating, by the one or more processors, a first service hash based on application of a hash function to a tuple formed from an IP address and a port of a first service of the plurality of services. The method can include generating, by the one or more processors, a plurality of replicas based on combining the first service hash with one or more prime numbers selected from a prime number array. The method can include storing, by the one or more processors, the plurality of replicas in the table to route requests to access the first service.

The method can include determining, by the one or more processors, a first count of replicas to generate based on a replication factor for the first service. The method can include generating, by the one or more processors, the plurality of replicas with the first count of replicas.

The method can include determining, by the one or more processors, a first count of replicas to generate based on a replication factor for the first service and a first weight of the first service. The method can include generating, by the one or more processors, the plurality of replicas with the first count of replicas.

The method can include generating, by the one or more processors, a first service hash based on application of a hash function to a tuple formed for a first service of the plurality of services. The method can include generating, by the one or more processors, a plurality of replicas based on application of the hash function or a second hash function to the first service hash combined with a second one or more values selected from an array. The method can include storing, by the one or more processors, the plurality of replicas in the table to route requests to access the first service.

The method can include determining, by the one or more processors, that a first service of the plurality of services is unavailable. The method can include removing, by the one or more processors from the table, replicas generated for the first service to cause subsequent requests for the first service to be routed to a different service of the plurality of services.

In an aspect, this technical solution can be directed to a non-transitory computer readable medium storing instructions. The instructions, which when executed by one or more processors, can cause the one or more processors to maintain a table of a count of replicas of each of a plurality of services that is generated based on a weight of each of the plurality of services. The instructions, which when executed by one or more processors, can cause the one or more processors to receive, from a client device remote from the one or more processors, a request. The instructions, which when executed by one or more processors, can cause the one or more processors to select, from the table based on the request, a service of the plurality of services. The instructions, which when executed by one or more processors, can cause the one or more processors to route the request to the selected service of the plurality of services.

These and other aspects and implementations are discussed in detail below. The foregoing information and the following detailed description include illustrative examples of various aspects and implementations, and provide an overview or framework for understanding the nature and character of the claimed aspects and implementations.

### BRIEF DESCRIPTION OF THE FIGURES

The foregoing and other objects, aspects, features, and advantages of the present solution will become more apparent and better understood by referring to the following description taken in conjunction with the accompanying drawings, in which:

FIG. 1A is a block diagram of embodiments of a computing device;

FIG. 1B is a block diagram depicting a computing environment comprising client device in communication with cloud service providers;

FIG. 2 is a block diagram of a system for weight-based distribution for consistent hashing algorithm, in accordance with an embodiment;

FIG. 3 depicts example illustrations of the distribution of items into buckets, in accordance with an embodiment;

FIG. 4 is an example diagram representing service hashes for a certain replication factor number, in accordance with an embodiment;

FIG. 5 is an example diagram for implementing collision avoidance for finger placement, in accordance with an embodiment;

FIG. 6 is an example diagram for inserting replicas in a table, in accordance with an embodiment;

FIG. 7 is a flow diagram of an example method for weight-based distribution for consistent hashing algorithm, in accordance with an embodiment; and

FIG. 8 is a flow diagram of another example method for weight-based distribution for consistent hashing algorithm, in accordance with an embodiment.

The features and advantages of the present solution will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

For purposes of reading the description of the various embodiments below, the following descriptions of the sections of the specification and their respective contents may be helpful:

Section A describes a computing environment which may be useful for practicing embodiments described herein; and

Section B describes systems and methods of weight-based distribution for consistent hashing algorithm.

### A. Computing Environment

Prior to discussing the specifics of embodiments of the systems and methods of an appliance and/or client, it may be helpful to discuss the computing environments in which such embodiments may be deployed.

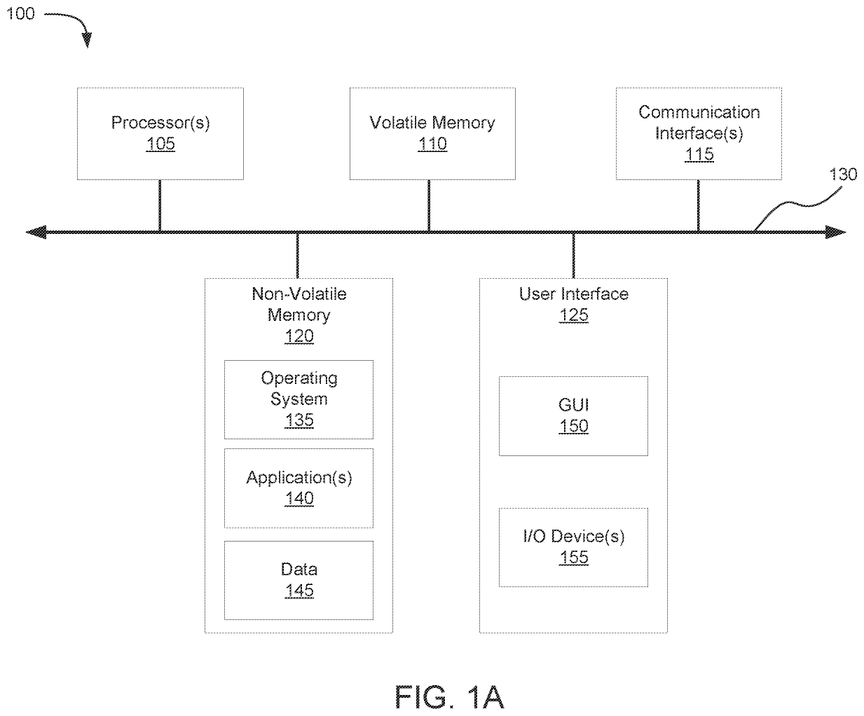

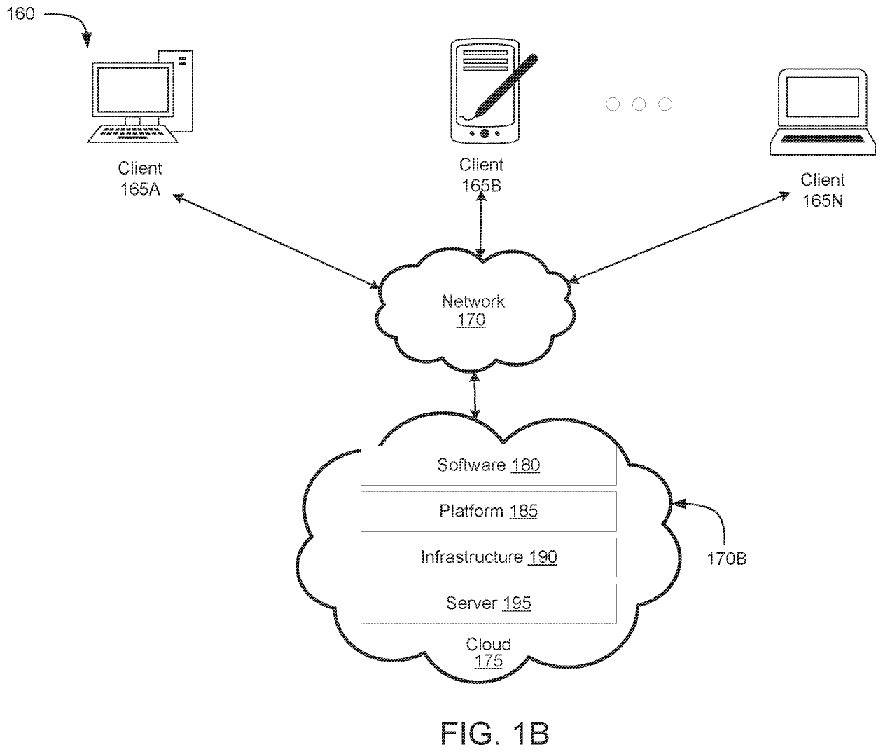

As shown in FIG. 1A, computer 100 may include one or more processors 105, volatile memory 110 (e.g., random access memory (RAM)), non-volatile memory 120 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 125, one or more communications interfaces 115, and communication bus 130. User interface 125 may include graphical user interface (GUI) 150 (e.g., a touchscreen, a display, etc.) and one or more input/output (I/O) devices 155 (e.g., a mouse, a keyboard, a microphone, one or more speakers, one or more cameras, one or more biometric scanners, one or more environmental sensors, one or more accelerometers, etc.). Non-volatile memory 120 stores operating system 135, one or more applications 140, and data 145 such that, for example, computer instructions of operating system 135 and/or applications 140 are executed by processor(s) 105 out of volatile memory 110. In some embodiments, volatile memory 110 may include one or more types of RAM and/or a cache memory that may offer a faster response time than a main memory. Data may be entered using an input device of GUI 150 or received from I/O device(s) 155. Various elements of computer 100 may communicate via one or more communication buses, shown as communication bus 130.

Computer 100 as shown in FIG. 1A is shown merely as an example, as clients, servers, intermediary and other networking devices and may be implemented by any computing or processing environment and with any type of machine or set of machines that may have suitable hardware and/or software capable of operating as described herein. Processor(s) 105 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A “processor” may perform the function, operation, or sequence of operations using digital values and/or using analog signals. In some embodiments, the “processor” can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors. A processor including multiple processor cores and/or multiple processors multiple processors may provide functionality for parallel, simultaneous execution of instructions or for parallel, simultaneous execution of one instruction on more than one piece of data.

Communications interfaces 115 may include one or more interfaces to enable computer 100 to access a computer network such as a Local Area Network (LAN), a Wide Area Network (WAN), a Personal Area Network (PAN), or the Internet through a variety of wired and/or wireless or cellular connections.

In described embodiments, the computing device 100 may execute an application on behalf of a user of a client computing device. For example, the computing device 100 may execute a virtual machine, which provides an execution session within which applications execute on behalf of a user or a client computing device, such as a hosted desktop session. The computing device 100 may also execute a terminal services session to provide a hosted desktop environment. The computing device 100 may provide access to a computing environment including one or more of: one or more applications, one or more desktop applications, and one or more desktop sessions in which one or more applications may execute.

Referring to FIG. 1B, a computing environment 160 is depicted. Computing environment 160 may generally be considered implemented as a cloud computing environment, an on-premises (“on-prem”) computing environment, or a hybrid computing environment including one or more on-prem computing environments and one or more cloud computing environments. When implemented as a cloud computing environment, also referred as a cloud environment, cloud computing or cloud network, computing environment 160 can provide the delivery of shared services (e.g., computer services) and shared resources (e.g., computer resources) to multiple users. For example, the computing environment 160 can include an environment or system for providing or delivering access to a plurality of shared services and resources to a plurality of users through the internet. The shared resources and services can include, but not limited to, networks, network bandwidth, servers, processing, memory, storage, applications, virtual machines, databases, software, hardware, analytics, and intelligence.

In embodiments, the computing environment 160 may provide client 165 with one or more resources provided by a network environment. The computing environment 160 may include one or more clients 165a-165n, in communication with a cloud 175 over one or more networks 170. Clients 165 may include, e.g., thick clients, thin clients, and zero clients. The cloud 175 may include back end platforms, e.g., servers, storage, server farms or data centers. The clients 165 can be the same as or substantially similar to computer 100 of FIG. 1A.

The users or clients 165 can correspond to a single organization or multiple organizations. For example, the computing environment 160 can include a private cloud serving a single organization (e.g., enterprise cloud). The computing environment 160 can include a community cloud or public cloud serving multiple organizations. In embodiments, the computing environment 160 can include a hybrid cloud that is a combination of a public cloud and a private cloud. For example, the cloud 175 may be public, private, or hybrid. Public clouds 175 may include public servers that are maintained by third parties to the clients 165 or the owners of the clients 165. The servers may be located off-site in remote geographical locations as disclosed above or otherwise. Public clouds 175 may be connected to the servers over a public network 170. Private clouds 175 may include private servers that are physically maintained by clients 165 or owners of clients 165. Private clouds 175 may be connected to the servers over a private network 170. Hybrid clouds 175 may include both the private and public networks 170 and servers.

The cloud 175 may include back end platforms, e.g., servers, storage, server farms or data centers. For example, the cloud 175 can include or correspond to a server or system remote from one or more clients 165 to provide third party control over a pool of shared services and resources. The computing environment 160 can provide resource pooling to serve multiple users via clients 165 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In embodiments, the computing environment 160 can provide on-demand self-service to unilaterally provision computing capabilities (e.g., server time, network storage) across a network for multiple clients 165. The computing environment 160 can provide an elasticity to dynamically scale out or scale in responsive to different demands from one or more clients 165. In some embodiments, the computing environment 160 can include or provide monitoring services to monitor, control and/or generate reports corresponding to the provided shared services and resources.

In some embodiments, the computing environment 160 can include and provide different types of cloud computing services. For example, the computing environment 160 can include Infrastructure as a service (IaaS). The computing environment 160 can include Platform as a service (PaaS). The computing environment 160 can include server-less computing. The computing environment 160 can include Software as a service (SaaS). For example, the cloud 175 may also include a cloud based delivery, e.g. Software as a Service (SaaS) 180, Platform as a Service (PaaS) 185, Infrastructure as a Service (IaaS) 190, and Server as a Service (SaaS) 195. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g. DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

Clients 165 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 165 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 165 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, California). Clients 165 may also access SaaS resources through smartphone or tablet applications, including, e.g., Salesforce Sales Cloud, or Google Drive app. Clients 165 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

### B. Systems and Methods of Weight-Based Distribution for Consistent Hashing Algorithm

Systems and methods of weight-based distribution for consistent hashing algorithm to endpoint devices (e.g., servers or backend services) are provided. Clients and servers can exchange information or data (e.g., data packets) to perform operations or tasks, access resources, among others by establishing communication sessions. Data sent to the servers can be in the form of traffic, which can be distributed to various servers available in a computing environment. An application delivery controller (“ADC”) can manage the distribution or which server to forward the traffic from clients. The ADC can adapt to the increase in dynamic application workloads as servers automatically scale to adjust the amount of computational resources in a server farm used to handle or process requests from client devices.

The servers in the computing environment can be deployed using a stateless mesh architecture, which can achieve 99.9999% reliability, for example. The ADC can use a consistent hash algorithm as a method for distributing traffic to the servers deployed with stateless architectures. The ADC can use the consistent hash algorithm to achieve both fault tolerance and uniform load distribution. However, in certain deployment scenarios, the ADC may experience managing a disproportionate load. For example, it can be challenging for the consistent hashing algorithm to account for load balancing multiple points of presence (POPs) (e.g., servers or services) with different capacities or capabilities in regard to their storage or computing power, or diverting different amounts of traffic to various sites according to the service rate structure (e.g., pricing or cost) or region affinity, among other factors.

The systems and methods of this technical solution can provide mechanisms or techniques to factor in weights to consistent hashing algorithms. The weights can be based on the capability or capacity (e.g., processing power or storage) of the servers receiving requests from the client devices. For example, a relatively higher weight (e.g., a higher number) can be assigned to servers with relatively higher capacity and a relatively lower weight (e.g., a lower number) can be assigned to servers with relatively lower capacity. The systems and methods can generate a number or count of replicas of the servers according to at least the weight associated with the servers. By replicating the server instance, the systems and methods can manage (or cater) requests to the disproportionate load, thereby improving the distribution of resources or demand, minimizing resource consumption (e.g., minimize CPU usage), and avoiding server overload.

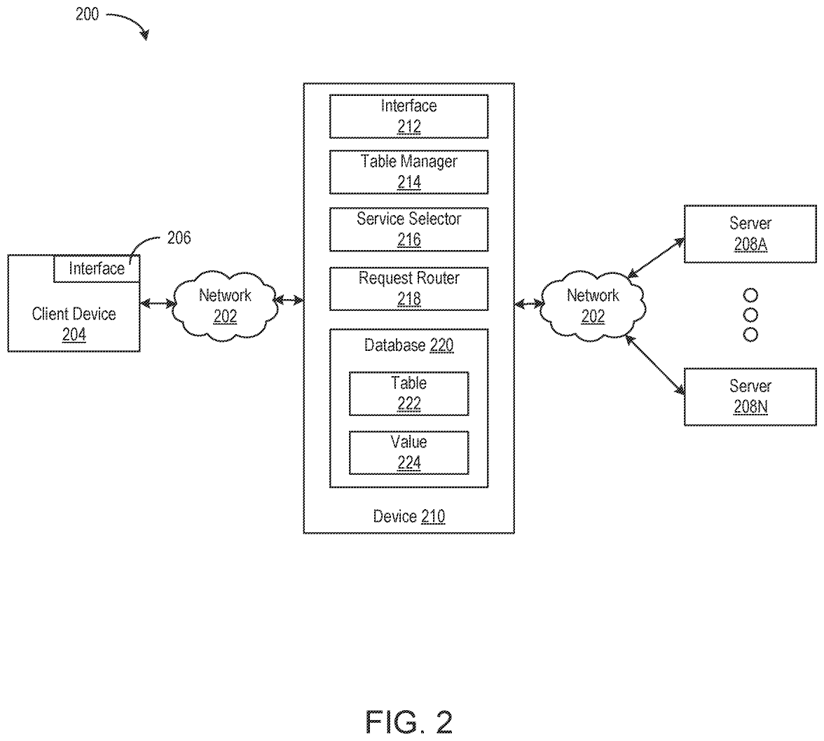

FIG. 2 depicts a block diagram of a system 200 for weight-based distribution for consistent hashing. The system 200 can include, interface with, or utilize one or more networks 202. The system 200 can include, interface with, or communicate with at least one client device 204. The system 200 can include, interface with, or utilize one or more servers 208A-N (sometimes generally referred to as server(s) 208). The system 200 can include, interface with, or utilize at least one device 210. The device 210 can include or be an ADC, a distributed system, or an intermediary appliance executing between the client device 204 and the servers 208. Although the ADC can be used as an example, the features or operations for weight-based distribution can be implemented for any stateless or distributed architecture, for instance, utilizing consistent hashing, with different capabilities across its instances (e.g., different server capacity), for example. The one or more components (e.g., client device 204, servers 208, or device 210) of the system 200 can establish communication channels or transfer data via the network 202. For example, the client device 204 can communicate with the device 210 through a first network and the device 210 can communicate with servers 208 via a second network. In some cases, the first network and the second network can be the same network 202. In some cases, the first network and the second network may be different networks 202 bridging or enabling communication between different devices or components of the system 200. The traffic from the client device 204 can be handled by at least one of the servers 208. The device 210 can route or forward the traffic to one of the servers 208.

The network 202 can include computer networks such as the Internet, local, wide, metro or other area networks, intranets, satellite networks, other computer networks such as voice or data mobile phone communication networks, and combinations thereof. The network 202 may be any form of computer network that can relay information between the one or more components of the system 200. The network 202 can relay information between client devices 204 and one or more information sources, such as web servers or external databases, amongst others. In some implementations, the network 202 may include the Internet and/or other types of data networks, such as a local area network (LAN), a wide area network (WAN), a cellular network, a satellite network, or other types of data networks. The network 202 may also include any number of computing devices (e.g., computers, servers, routers, network switches, etc.) that are configured to receive and/or transmit data within the network 202. The network 202 may further include any number of hardwired and/or wireless connections. Any or all of the computing devices described herein (e.g., client device 204, servers 208, or device 210) may communicate wirelessly (e.g., via Wi-Fi, cellular, radio, etc.) with a transceiver that is hardwired (e.g., via a fiber optic cable, a CAT5 cable, etc.) to other computing devices in the network 202. Any or all of the computing devices described herein (e.g., client device 204, servers 208, or device 210) may also communicate wirelessly with the computing devices of the network 202 via a proxy device (e.g., a router, network switch, or gateway). In some implementations, the network 202 can be similar to or can include the network 170 or a computer network accessible to the computer 100 described herein above in conjunction with FIG. 1A or 1B.

The system 200 can include, interface with, or communicate with at least one client device 204 (or various client devices 204). Client device 204 can include at least one processor and a memory, e.g., a processing circuit. The client device 204 can include various hardware or software components, or a combination of both hardware and software components. The client devices 204 can be constructed with hardware or software components and can include features and functionalities similar to the client devices 165 described hereinabove in conjunction with FIGS. 1A-B. For example, the client devices 165 can include, but is not limited to, a television device, a mobile device, smart phone, personal computer, a laptop, a gaming device, a kiosk, or any other type of computing device.

The client device 204 can include at least one interface 206 for establishing a connection to the network 202. The client device 204 can communicate with other components of the system 200 via the network 202, such as the device 210 or the servers 208. The interface 206 can include hardware, software, features, and functionalities of at least a communication interface(s) 115 or user interface 125 as described hereinabove in conjunction with FIG. 1A. For example, the client device 204 can communicate data packets with one or more servers 208 through a device 210 intermediate between the client device 204 and the servers 208. The client device 204 can transmit data packets to the device 210 configured to select and forward the data packets from the client device 204 to at least one server 208. In some cases, the client device 204 can communicate with other client devices.

The client device 204 can include, store, execute, or maintain various application programming interfaces (“APIs”) in the memory (e.g., local to the client device 204). The APIs can include or be any types of API, such as Web APIs (e.g., open APIs, Partner APIs, Internal APIs, or composite APIs), web server APIs (e.g., Simple Object Access Protocol (“SOAP”), XML-RPC (“Remote Procedure Call”), JSON-RPC, Representational State Transfer (“REST”)), among other types of APIs or protocol described hereinabove in conjunction with clients 165 of FIG. 1B. The client device 204 can use at least one of various protocols for transmitting data to the server 208. The protocol can include at least a transmission control protocol (“TCP”), a user datagram protocol (“UDP”), or an internet control message protocol (“ICMP”). The data can include a message, a content, a request, or otherwise information to be transmitted from the client device 204 to a server 208. The client device 204 can establish a communication channel or a communication session with a server 208 selected by the device 210 to maintain uniformity in load balancing across the servers 208. In some cases, the client device 204 can transmit data to the server 208 via an established communication session. In some other cases, the device 210 can intercept data from the client device 204 and determine which server 208 should be handling information from the client device 204.

The system 200 can include, interface with, or communicate with one or more servers 208. The one or more of the servers 208 can include, be, or be referred to as a node, remote devices, remote entities, application servers, backend server endpoints, or backend services. The servers 208 can be part of, located in, or form a cloud computing environment. The server 208 can be composed of hardware or software components, or a combination of both hardware or software components. The server 208 can include resources for executing one or more applications, such as SaaS applications, network applications, or other applications within a list of available resources maintained by the server 208. The server 208 can include one or more features or functionalities of at least resource management services or other components within the cloud computing environment. The server 208 can communicate with the client device 204 via a communication channel established by the network 202, for example.

The server 208 can receive data packets or traffic from at least the client device 204 via the device 210. The server 208 can be selected by the device 210 to serve or handle the traffic from various clients. The server 208 can be associated with a server hash or an index in a list of servers within a hash table. In some cases, the server 208 can include or be a virtual server. In this case, the virtual server can include a hash table including indices listing backend services. Selecting a backend service can refer to or be similar to selecting a server 208 to handle a request from the client device 204, as discussed herein. The server 208 can be selected by the device 210 using at least one of various consistent hash algorithms. The server 208 can be selected by the device 210 using a weight-based hash table, or other types of distribution techniques.

The server 208 can establish a communication session with the client device 204 responsive to the device 210 selecting the server 208 to handle the traffic from the client device 204. The server 208 can serve the traffic based on the request or instructions from the client device 204, such as to store information, update or configure data on the server, obtain data from the server, among others. The server 208 can transmit data packets to the client device 204 to acknowledge receipt of the data packets or to satisfy a request, for example. The server 208 can communicate with the client device 204 directly after establishing the communication session. In some cases, the server 208 can transmit data packets to the client device 204 through an intermediary device, such as the device 210. In some cases, the server 208 can transmit data packets to the device 210 indicating the availability of the server 208 to handle requests. In some cases, a lack of data packets or response from the server 208 to the device 210 can indicate that the server 208 is not available to handle requests.

The system 200 can include at least one device 210. The device 210 can refer to or include an intermediary device, an appliance, a data processing system, a distributed system, or an Application Delivery Controller (“ADC”), for example. The device 210 can be composed of hardware or software components, or a combination of hardware and software components. The device 210 can be intermediate between client devices 204 and servers 208. The device 210 can include features or functionalities of an ADC or a distributed system. For instance, the device 210 may manage the request to establish a communication session from the client device 204 to the server 208. The requests or data packets from the client devices 204 to the servers 208 can be referred to as traffic. The device 210 can manage communication flow between the client devices 204 and the servers 208 by forwarding the traffic from the client devices 204 to one or more servers 208. In some cases, the device 210 can manage traffic from the client devices 204 without managing traffic from the servers 208 to the client devices 204. The device 210 may not alter the content of the data packets from the client device 204 or the server 208. The device 210 can include other components (e.g., processors and memory) to perform features and functionalities described herein.

The device 210 can include various components to manage traffic from the client device 204 to the servers 208. The device 210 can include at least one interface 212, at least one table manager 214, at least one service selector 216, at least one request router 218, and at least one database 220. The database 220 can include at least one table storage 222 and at least one value storage 224. The table storage 222 can be referred to generally as table 222, a hash table, map storage, or hash storage. The value storage 224 can be referred to generally as value 224, index storage, or hash value storage. Individual components (e.g., interface 212, table manager 214, service selector 216, request router 218, or database 220) of the device 210 can be composed of hardware, software, or a combination of hardware and software components. Individual components can be in electrical communication with each other. For instance, the interface 212 can exchange data or communicate with the one or more components of the device 210 (e.g., table manager 214, service selector 216, request router 218, or database 220). The one or more components (e.g., interface 212, table manager 214, service selector 216, request router 218, or database 220) of the device 210 can be used to perform features or functionalities discussed herein, such as generating a weight-based table, balance or distribute loads across different servers 208, lookup at least a server 208 to handle requests from the client device 204, etc.

The interface 212 can interface with the network 202, devices within the system 200 (e.g., client devices 204 or servers 208), or components of the device 210. The interface 212 can include features and functionalities similar to the communication interface 115 to interface with the aforementioned components, such as in conjunction with FIG. 1A. For example, the interface 212 can include standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). The interface 212 can include at least a built-in network adapter, network interface card, PCMCIA network card, EXPRESSCARD network card, card bus network adapter, wireless network adapter, USB network adapter, modem, or any other device suitable for interfacing one or more devices within the system 200 to any type of network capable of communication. The interface 212 can communicate with one or more aforementioned components to receive data from client devices 204 for forwarding to one of the servers 208 to perform load balancing or request routing.

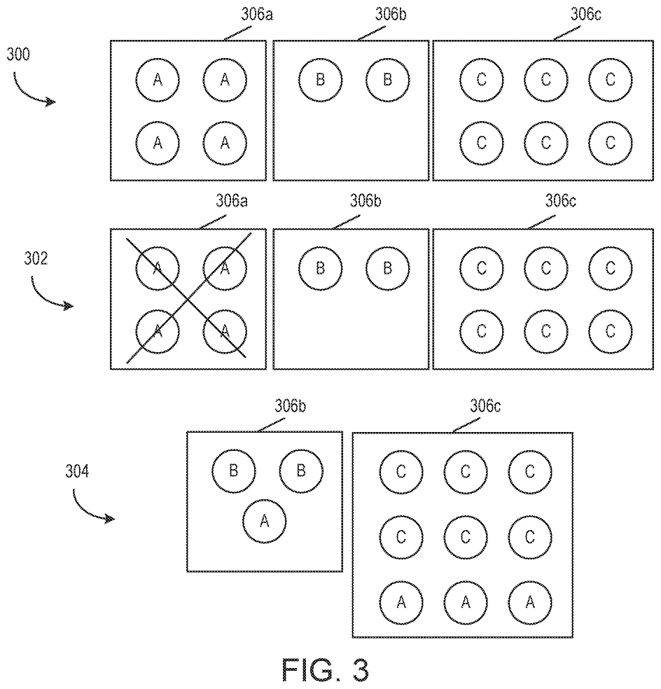

The one or more components of the device 210 can provide mechanisms for consistent distribution of incoming requests to load balance across various services or servers 208, such as described in conjunction with but not limited to FIG. 3. The one or more components of the device 210 can provide weight support for consistent hashing algorithms to maintain relatively high consistency with a distribution defined by the weights. The term distribution discussed herein may include or refer to a division of load and methods for allocating “m” number of items (e.g., can be associated with the client devices 204) in “n” number of buckets (e.g., can be associated with the servers 208). For example, a 100% distribution can be achieved when the m items are divided into the n buckets based on the weights without collision to provide utilization of the various servers 208 based on their availability criteria.

Further, the term consistency discussed herein may include or refer to a property that describes the ability to map the same set of client devices 204 and servers 208, for instance, when the servers 208 are added or removed. For example, for “m” number of client devices 204 (or clients) that are being served by a first server (e.g., a backend) of “n” number of servers 208, if the first server is removed, these m clients can be moved or transferred to at least one of the other (n−1) servers 208 based on the weights of the servers 208. In this case, the client devices 204 (or items) that are assigned to the (n−1) servers 208 should not move to other servers 208 when the client devices 204 from the first server are moved. If the previously removed server 208 (e.g., the first server) is brought back online (e.g., active status), the set of one or more client devices 204 previously moved to the other (n−1) servers 208 can be moved back to the first server. The term resource can include or refer to, for any given task of looking up an “x” number of times in the system 200, a certain amount of CPU can be utilized to complete the task.

FIG. 3 depicts example illustrations 300-304 of the distribution of items into buckets. The example features and functionalities described herein can be executed, performed, or otherwise carried out by one or more components of the system 200 (e.g., client device(s) 204, device 210, or servers 208), the computer 100, or any other computing devices described herein in conjunction with FIG. 1A-B and FIG. 2. The illustrations 300-304 can include buckets (e.g., servers 208) serving a number of items representing loads, requests, data packets, or traffic from various client devices 204. The illustrations 300-304 can be used as an example to describe a scenario where the device 210 can provide good distribution and consistency.

The illustration 300 shows three buckets 306a-c (e.g., buckets A-C, respectively) with items allocated in the (e.g., weight) ratio 2:1:3, such as bucket 306a handling (or catering to) four items A, bucket 306b handling two items B, and bucket 306c handling six items C. These items may be distributed across the buckets 306a-c according to the capacity of the buckets 306a-c. The capacity of individual buckets 306a-c can be indicative of the weight across the servers 208.

For example, in some cases, each of the buckets 306a-c may include or correspond to a server. In this example, during a first time window, three servers can be online or available: server 306a, server 306b, and server 306c. Each server can handle or a service a number of client devices. For example, server 306a can be handling or servicing four client devices; server 306b can be handling or servicing two client devices; and server 306c can be handling or servicing 6 client devices. Thus, the load-based ratio or weight across servers 306a, 306b and 306c can be 2:1:3.

The illustration 302 shows the removal of bucket 306a. For example, during a second time window subsequent to the first time window illustrated in 300, server 306a may be unavailable, inaccessible, or otherwise removed. For example, with server flaps, maintenance, or interruptions, a bucket or a server 208 can go down or become unavailable, such as illustrated in illustration 302 having an “X” representing a removal of the bucket index from consideration in the subset.

To maintain effective distribution and consistency in order to service client devices without introducing latencies, network delay, or causing excess computing resource utilization via a new handshaking process, the illustration 304 shows, during a third time window subsequent to the second time window, the movement of items A when the server 208 (or the bucket 306a) goes down. In this case, the traffic from the bucket 306a can be rerouted or forwarded based on the weight ratio of the available buckets 306b-c (e.g., weight ratio 1:3). In this case, of the four items placed in the removed bucket 306a, one item A can be rerouted to bucket 306b and three item A can be rerouted to bucket 306c according to the weight ratio. No other items should move from the buckets 306b-c that are unaffected (e.g., not down or still available). Further, in the case that bucket 306a is brought back, only items previously moved from the removed bucket (e.g., item A) can be moved to the added bucket. Hence, no other items should move to the added bucket or other buckets. With the item movements in the example illustration 304, the device 210 can provide consistency in load balancing of the items. Accordingly, illustrations 300-304 can present example movements of items (e.g., traffic) from one bucket to one or more other buckets as a result of one bucket becoming unavailable.

The device 210 can include the table manager 214. The table manager 214 can generate, update, or otherwise manage one or more tables (e.g., weighted or weight-based tables) for load balancing the servers 208. The table can include or correspond to a hash table. For example, the table manager 214 can be configured to generate the weighted hash table by creating replicas (or duplicates) for a given backend or service including or corresponding to a respective server 208, performing collision avoidance for finger (e.g., replica) placement, and inserting the generated replicas into the table to facilitate lookup for load balancing. In some cases, the services can include virtual machines hosted in the cloud computing environment. The replicas stored in the hash table can refer to or include identifiers, pointers, or addresses to the corresponding service or service associated with the replica.

The replicas of the service can be associated with or represented by generated hashes. To create replicas (or a set of hashes) for individual services (or servers 208), the table manager 214 can consider at least the weight of the service to determine the number or count of replicas to generate for each of the services. The weight of the service can be based on the capacity (e.g., processing or storage capacity) of the server 208. For example, a server 208 with a relatively high capacity can be associated with a relatively higher weight, and a server 208 with a relatively lower capacity can be associated with a relatively lower weight. The table manager 214 can determine to generate a relatively higher number of replicas for each service with relatively higher capacity, and a relatively lower number of replicas (or no replicas) for each service with relatively lower capacity, for example.

In some cases, the table manager 214 can determine the count of replicas based on a replication factor or a combination of the weight of the service and the replication factor. The replication factor can be based on the size of the table, such as the table stored in the database 220 or other data storage. The table manager 214 can determine the count of replicas by aggregating the weight of the respective service and the replication factor. For purposes of providing examples herein, the table manager 214 can multiply the weight by the replication factor (e.g., multiplication factor), although other aggregation techniques can be utilized, such as summation or other aggregation techniques. For example, “N” can represent the number of fingers or replication factor for a weight of 1 for each of the service or backend. The N replication factor can be predetermined by the system 200 (e.g., the device 210 or the server 208) or configured by the administrator of the system 200. By using the replication factor, the table manager 214 can allow the placement of more instances of the service in the table for weighted load balancing. The table manager 214 can generate or create the replicas for each service by performing, but not limited to, the example procedures or operations as follows:

```
# Array of large prime numbers
Array prime [P1 ... Px] //x=>2 times greater than the table
int N
For EachService
  serviceHash = hash(serviceIP, Port) // Can be any hash function
  For (i=0; i < N * ServiceWeight; i₊₊)
    service.Hash[i] = hash(serviceHash \hat{ } prime[i]) // can be any hash
    function
  Endfor
Endfor
```

For example, the table manager 214 can obtain a list or array of relatively large prime number. The number of prime numbers can be greater than or equal to two times the size of the table. For each service, the table manager 214 can generate a hash value (e.g., service hash) based on application of at least one hash function to a tuple. The table manager 214 can utilize any suitable hash function, such as basic consistent hashing, Ketama hashing, maglev hashing, multi-hashing, jump hash, rendezvous hashing, etc. The tuple can include or be formed from information of the server 208 (or service), such as at least one of the internet protocol (IP) address, port, media access control (MAC) address, or other identifiers formed for the server 208. Using the generated hash value and for the determined count of replicas according to N*weight of the service, the table manager 214 can generate the replicas of the service. Individual replicas can be associated with respective hash values, generated based on combining the hash value of the service with one or more prime numbers selected from the prime number array.

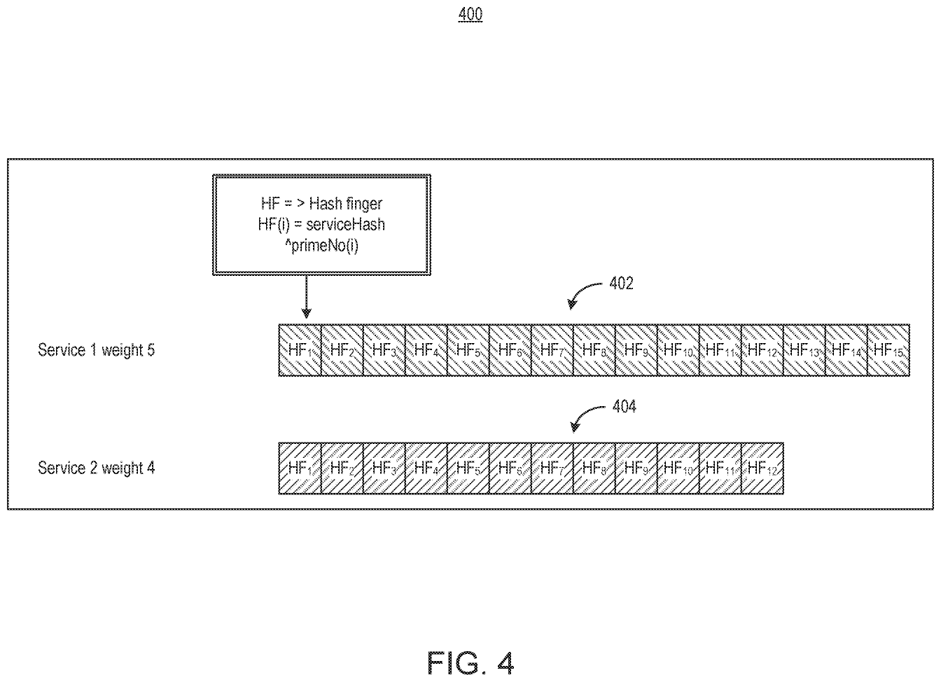

For example, the table manager 214 can generate a first replica by applying a bitwise XOR operation (e.g., “\hat{ }” operation) between the hash value and a first prime number selected from the prime number array. The first prime number can be the first prime number stored in the prime number array (e.g., lowest prime number, highest prime number, or other prime numbers depending on the sorting technique) or a first random prime number from the prime number array. The table manager 214 can apply at least one suitable hash function to the result of the bitwise XOR operation to generate the first replica. The table manager 214 can generate a second replica by applying the bitwise XOR operation between the hash value and a second prime number. The table manager 214 can perform similar operations to generate the remaining number of replicas, for example. The table manager 214 can use a similar or different hash function as used for generating the hash value to generate the replicas, such as using a first hash function, a second hash function, or other hash functions. Examples of generating the replicas can be shown in, but not limited to, FIG. 4.

FIG. 4 depicts an example diagram 400 representing service hashes for a certain replication factor number, in accordance with an embodiment. The example diagram 400 can include an example array 402 and array 404. The example arrays 402, 404 can be constructed by one or more components of the device 210 (e.g., the table manager 214). For example, the table manager 214 can determine a weight of 5 for a first service (e.g., service 1) and a weight of 4 for a second service (e.g., service 2). In this case, the first service can include a relatively higher capacity compared to the second service. The table manager 214 can be configured with a replication factor of 3, such as according to the size of the table. With the replication factor of 3, the table manager 214 can determine 5*3=15 total replicas for the first service, and 4*3=12 total replicas for the second service. Accordingly, using the operations discussed herein, the table manager 214 can construct the array 402 including 15 replicas (e.g., hash fingers or finger hash values) representing the first service of weight 5, and the array 404 including 12 replicas representing the second service of weight 4. Each replica can be represented by a respective hash finger (e.g., sometimes referred to as a hash value, service hash, or generally as a value).

The table manager 214 can implement collision avoidance for finger (e.g., hash finger) placement or placement of replicas in the hash table. For example, the table manager 214 can ensure that collision is avoided when inserting the replicas of each service into the same index or placement of the table. For instance, with the increase in the weight of a particular service, thereby increasing the number of fingers or replicas of the service, there may be a potential collision (e.g., selection of the same index) when attempting to insert the replicas in the table. To avoid the collision, the table manager 214 can maintain a mask (e.g., hash mask) for each service. The hash mask can represent the size of the table, used for collision detection. For example, the hash mask can include or indicate one or more indices of the table that are mapped to one or more respective fingers. In another example, the hash mask can include or indicate one or more indices of the table that are not mapped to one or more respective fingers.

In some cases, the table manager 214 can utilize the hash mask responsive to or after detecting a collision (e.g., the index to place the finger has been mapped). In some other cases, the table manager 214 can utilize the hash mask to avoid having to detect the collision, for example. According to the hash mask, the table manager 214 can compute or recompute the placement of the finger (or replica) to its suitable index (or different index) within the table. Example operations or procedures for collision avoidance can include or be performed, but not limited to, as follows:

```
#Array of large prime numbers
Array prime[P1 ... Px] //x=> Twice the size of hash table
For Each serviceFinger
Calculate_service_hash_and_index:
  service.hash = serviceHash \hat{ } prime[i]
  hashTableIndex = (service.Hash % hashTableSize) //finger value
  modulus table size
  While(IsHashMaskSet(serviceHashMask[hashTableIndex])) Do
    goto Calculate_service_hash_and_index //Using different prime
    number
  Endwhile
  hashMaskSet(serviceHashMask[hashTableIndex])
Endfor
```

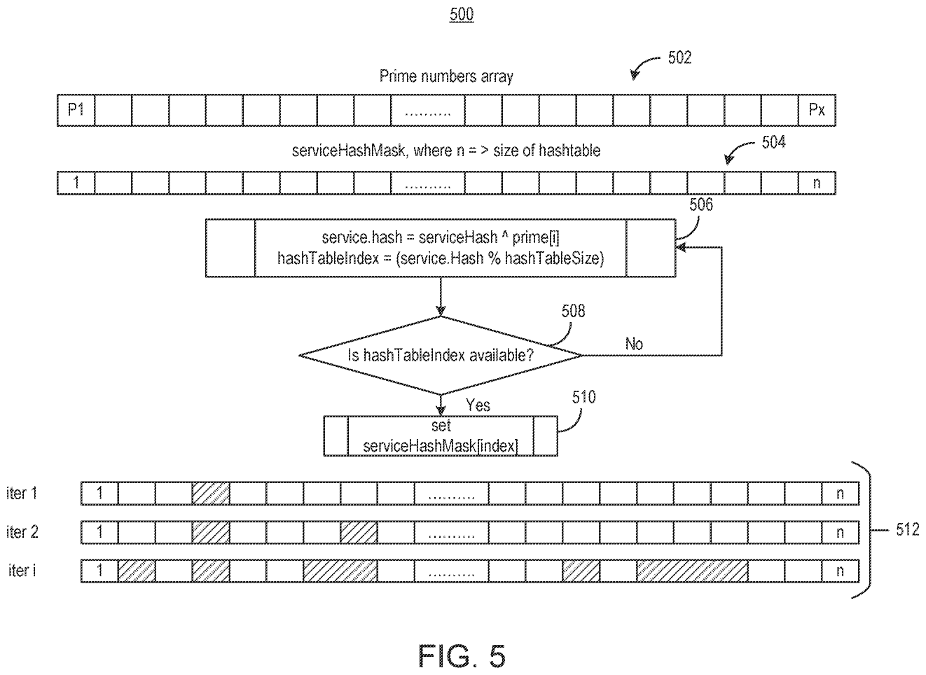

For each finger of the service, the table manager 214 can determine the value of the finger (e.g., hash finger) by applying the bitwise XOR operation between the hash value of the service and the prime number. The table manager 214 can obtain the index for the finger by applying a modulus of the table size to the hash finger, such that the index value is within the table size. While the hash mask is set (e.g., the index within the table is mapped to another finger, hash mask index=1), the table manager 214 can recompute the index value for the finger using a different prime number. Responsive to identifying a hash mask that is not set (e.g., the index within the table has not been mapped, hash mask index=0), the table manager 214 can assign or associate the finger (or the replica) to the index and set the hash mask (e.g., set hash mask index to 1) to avoid potential collision. Example operations for implementing the collision avoidance can be described in conjunction with, but not limited to, FIG. 5.

FIG. 5 depicts an example diagram 500 for implementing collision avoidance for finger placement, in accordance with an embodiment. The operations of the example diagram 500 for collision avoidance can be performed by one or more components of the system 200 (e.g., the device 210), such as the table manager 214. The example diagram 500 can include a prime number array 502, which can be used for but not limited to replica generation and collision avoidance. The example diagram 500 can include a hash mask array 504 (e.g., service hash mask). The size of the hash mask array 504 can be greater than or equal to the size of the table. Each index of the hash mask array 504 can indicate whether a corresponding index of the table has been mapped. For instance, a hash mask index of ‘1’ can represent a mapped table index, and a hash mask index of ‘0’ can represent a non-mapped table index, or vice versa depending on the configuration. At ACT 506, the table manager 214 can compute the table index for a replica (or finger).

At ACT 508, the table manager 214 can determine whether the table index is available based on the corresponding hash mask index, where a set hash mask can indicate an unavailable index and an unset hash mask can indicate an available index. If the table index is not available, the table manager 214 can return to ACT 506 to identify another index for the replica. If the table index is available, the table manager 214 can proceed to ACT 510. At ACT 510, the table manager 214 can set the hash mask and assign the replica to the selected table index.

The arrays 512 can indicate iterations of updates to the hash mask array 504 (e.g., indices being set) in response to assigning replicas to indices of the table. For example, at iteration 1, one index within the hash mask array 504 can be set. At iteration 2, two indices within the hash mask array 504 can be set. At iteration i, an i number of indices within the hash mask array 504 can be set. In some cases, the table manager 214 can set the hash mask index before inserting the replica in the table. In some other cases, the table manager 214 can set the hash mask index after inserting the replica in the table.

To insert the replicas in the table to facilitate lookup for load balancing, the table manager 214 can utilize or execute, but not limited to, the following example operations:

```
//Insert all instances or replicas (calculated based on weight) of a given
service
//at different indices of the table as computed in conjunction with, but not
limited to, FIG. 5
For EachService
  For(i=0; i< N *serviceWeight; i++)
    hashIndex = service.Hash[i] % hashTableSize
    hashTable[hashIndex] = append(service)
      //Append service instance at given (or computed) index
  Endfor
Endfor
```

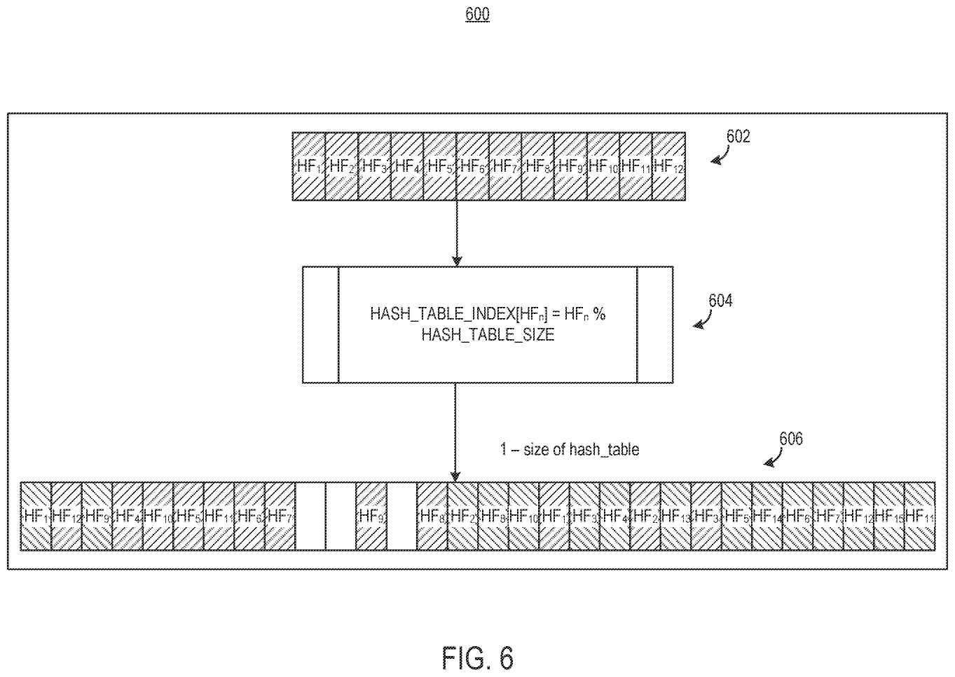

For example, for each service, the table manager 214 can determine a hash index for each replica by applying the modulus of the table size to the hash finger (e.g., finger hash value) of the replica. The table manager 214 can determine that there is no collision with the hash index. With the hash index, the table manager 214 can append the replica of the service (e.g., service instance) at the index of the table. The operations discussed herein for inserting the replicas in the table can be described in conjunction with, but not limited to FIG. 6.

FIG. 6 depicts an example diagram 600 for inserting replicas in the table (e.g., table 606 or hash table), in accordance with an embodiment. The operations or features for inserting the replicas in the table 606 of FIG. 6 can be performed by the one or more components of the system 200, such as by the table manager 214 of the device 210. The table 606 can be allocated or configured with a predetermined size. The generated number of replicas can represent the service instances to be inserted into individual indices of the table 606 to facilitate selection of backend or server 208 for load balancing and distribution of requests based on the weight of individual servers 208. As shown, the example diagram 600 can include array 602 corresponding to the array 404, including replicas of the second service with weight 4. The table manager 214 can insert the replicas of the second service into the table 606. For example, at ACT 604, the table manager 214 can determine or obtain the index of each replica by computing the modulus of the finger hash value by the table size (e.g., size of the table 606). The table manager 214 can ensure that the index of the replica is associated with an available index, for instance, using the hash mask of the collision avoidance operations. Accordingly, for each of the replicas, the table manager 214 can append the service instance (e.g., replica) of the second service to the determined index of the table 606. As shown in the example table 606, service instances of the first service (e.g., the 15 replicas of the first service with weight 5) may have been previously inserted into the table 606 before inserting the service instances of the second service. In various, the table (e.g., table 606) including indices of the replicas may be represented as or correspond to an array, list, matrix, or vector, among others.

The table manager 214 can store the table (e.g., table 606) in the database 220. In some cases, the table manager 214 can store the table in an external database on a remote device. In some other cases, the table manager 214 can update an existing table stored in the database 220 by inserting or adding the service instances to the indices of the existing table, such as subsequent to at least one server 208 being added or available to the client devices 204 within the system 200. In response to at least one server 208 becoming unavailable (e.g., the table manager 214 determines that the at least one server 208 is unavailable based on its status), the table manager 214 may update the existing table by removing or disabling the replicas associated with the unavailable server or service. By removing or disabling the replicas, requests (e.g., current or subsequent requests) for the unavailable server can be muted to a different server 208 (e.g., by the request router 218).

In some scenarios, the table manager 214 can determine that the previously unavailable server is available. In such cases, the table manager 214 can update the table (e.g., table 606) to include or enable the replicas generated for the previously unavailable server, thereby maintaining a consistent mapping of client devices to the servers 208. For example, when the service becomes unavailable because of maintenance, server flap, or other temporary conditions, the table manager 214 can disable the replicas, such as updating the table to indicate that the replicas associated with the unavailable service are disabled (e.g., using an indicator, marker, or placeholder). In this example, the hash mask indices can remain set because the replicas are not removed from the table. Once the same service becomes available, the table manager 214 can update the table by enabling the replicas, such that the requests from the client devices 204 to the service are maintained.

In another example, the table manager 214 may determine that at least one service is removed from the network 202 or the system 200, such as permanently removed. In this case, the table manager 214 can remove the replicas associated with the removed service from the table. With new services being added to the network 202, the table manager 214 can generate replicas for the new services and add the values of the replicas to the table, using collision avoidance, without affecting indices associated with the replicas of other services.

The device 210 can include the service selector 216. The service selector 216 can be configured to select at least one service for a request received from the client device 204. Selecting the service can include or correspond to selecting an index from the table (e.g., hash table or table 606), such as representing the server 208 to service the request from the client device 204. For example, the service selector 216 can receive a request from a client device 204 to access one of the services or servers 208 of the system 200. Responsive to receiving the request, the service selector 216 can determine a value (e.g., client hash value) based on at least a portion of the request received from the client device 204. The portion of the request can include at least one of an IP address, port, a uniform resource locator (“URL”) of the request of the client device 204, etc. In some cases, the service selector 216 can use other portions of the request to determine the client hash value. In some cases, the service selector 216 may use a prime number as part of computing the client hash value. The service selector 216 can utilize at least one suitable hash function to determine the client hash value for the request. The hash function can be similar to the hash function used to obtain the hash value of each service or the finger hash values. In some cases, the hash function may be different from the hash function used to obtain the hash value of each service or the finger hash values. By using the weighted table, the service selector 216 can select the indices which account for the weight (or capacity) of the services, thereby facilitating load balance and distribution based on weights.

In some aspects, after selecting the index from the table (or muting the request to the service), the service selector 216 can receive an indication (or determine) that the service (e.g., a first service) is unavailable. In this case, the service selector 216 can re-calculate or compute another client hash value for the request in response to the first service being unavailable. The service selector 216 can compute or select a second service for re-routing the request using similar client hash value or index computation techniques. In some configurations, the service selector 216 may keep track of requests that have been re-routed due to at least one service becoming unavailable, such as the one or more requests that were re-routed from the first service that became unavailable to the second service. In the case that the first service become available, the service selector 216 can route the one or more requests, previously re-routed from the first service to the second service, back to the first service, for example.

The device 210 can include the request router 218 configured to route the request received from the client devices 204 to the selected service. For example, the request router 218 can receive an indication that the service selector 216 selected a service (or a server 208) for the request received from the client device 204. Responsive to the selection by the service selector 216, the request router 218 can route the request to the suitable service. In some cases, if the service selector 216 selects an index from the table (e.g., hash table or table 606), the request router 218 can identify the service corresponding to the index from the table and route the request to the identified service. The request router 218 can re-route any requests to services selected by the service selector 216.

The device 210 can include the database 220. The database 220 can be referred to as a storage device, a data repository, or a memory. The database 220 can be physical storage volumes and virtual storage volumes or arrays thereof. The database 220 can include, store, or maintain information received from the client device 204. In some cases, the database 220 can store information received from the server 208. For example, the database 220 can store messages received from the client device 204 to be transmitted or forwarded to the server 208. In some cases, the database 220 can temporarily store data from the client device 204. The database 220 can discard or remove data packets from the client device 204 responsive to forwarding the data packets to at least one of the servers 208. The database 220 can store information from devices communicating with the database 220, such as source IP address, destination IP address, size of the message, fields in each message, etc., as allowed by the devices.

The database 220 can include the table storage 222 and the value storage 224. The table storage 222 can include, store, or maintain one or more tables (e.g., hash tables), bit maps, or jump tables, among other interchangeable terms. The table can include indices, hashes, fingers hash values, server hashes, or hash buckets listing the services (or servers 208) available (or in some cases temporarily unavailable or disabled) to service traffic from client devices 204. The table storage 222 can store the table with mapping of one or more indices to one or more respective service instances (or replicas) generated by the table manager 214, for example. The table storage 222 can be accessed by the table manager 214 for modifying or updating the table and the mapping of the indices and the services. The table storage 222 can be accessed by the service selector 216 to select an index of a service to handle the client request. The table storage 222 can store other information related to the hashes, hash table, bit map, or listing of servers 208, such as one or more parameters of the servers 208 used to generate server hashes.

The value storage 224 can store the values generated by the one or more components of the device 210 (e.g., the table manager 214). For example, the value storage 224 can store the values (e.g., hash values) generated for individual services. The value storage 224 can store finger hash values generated for individual replicas of each service. The value storage 224 can store an array of prime numbers, such as the prime number array 502, used for determining the finger hash values. The value storage 224 can store values for the hash mask array 504. The value storage 224 can store other values associated with the table. The values stored by the value storage 224 can be linked or associated with the table stored in the table storage 222. The value storage 224 can be accessed by the one or more components of the device 210 or other devices within the system 200 with access to the database 220.

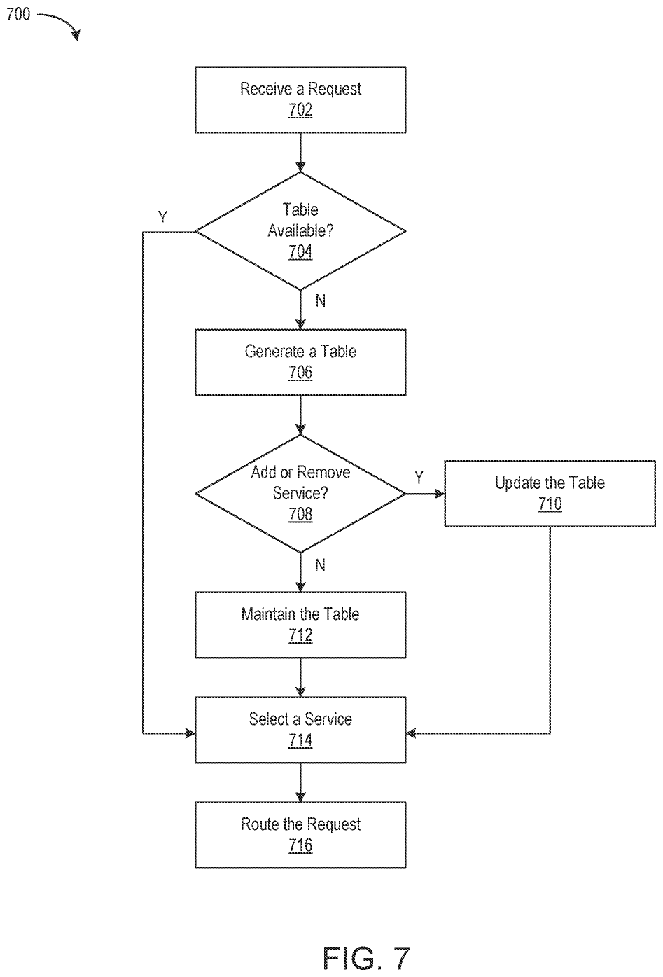

FIG. 7 depicts a flow diagram of an example method 700 for weight-based distribution for consistent hashing algorithm, in accordance with an embodiment. The example method 700 can be executed, performed, or otherwise carried out by one or more components of the system 200 (e.g., client devices 204, device 210, or servers 208), the computer 100, or any other computing devices described herein in conjunction with FIGS. 1A-B. The method 700 can include a device (e.g., a device intermediary to client devices and servers, including one or more processors, coupled with memory) receiving a request (702). The device can determine whether a table is available (704). The device can generate a table (706). The device can determine whether to add or remove a service (708). The device can update the table (710). The device can maintain the table (712). The device can select a service (714). The device can route the request (716).

In further detail, at ACT 702, the device can receive a request from a client device remote from the device (e.g., the one or more processors). The request can be a request to access at least one service. In some cases, the services can include or correspond to servers. In some cases, the services can include virtual machines hosted in a cloud computing environment, such as a server.

At ACT 704, the device can determine whether a table (e.g., hash table) is available, such as a table including indices representing services, generated based on weights of the services. If the table is not available for weighted load balancing or distribution based on weight, the device can proceed to ACT 706. If the table is available, the device can proceed to ACT 714.

At ACT 706, the device can generate a table for weight-based load balancing. To generate the table, the device can determine the count of replicas for individual services. For example, the device can determine a first count of replicas for a first service of the plurality of services based on a first weight of the first service. The device can determine a second count of replicas for a second service of the plurality of services based on a second weight of the second service. The weight of the service can represent the capacity of the service, such as processing capacity or storage capacity. If the weights of the first and second services are the same, the count of replicas of each service can be the same.

If the weights are different between the first service and the second service, the count of replicas for the first service and the second service may be different. For example, the first service may have a greater processing capacity compared to the second service. In this case, the first count of replicas can be greater than the second count of replicas, where the first weight can be greater than the second weight. In some cases, the device can determine the first count of replicas to generate based on a replication factor for the first service, such that the device can generate various replicas of the first service with the first count of replicas.

In some other cases, the device can determine the first count of replicas to generate based on a replication factor for the first service and the first weight of the first service. In this case, for instance, the device can multiply the first weight by the replication factor to determine the first count of replicas. Hence, the device can generate the various replicas of the first service with the first count of replicas.

Responsive to determining the count of replicas, the device can generate the replicas for each service. For example, the device can generate a first service hash based on the application of a hash function (e.g., consistent hash function) to a tuple formed from an IP address and a port of a first service of the plurality of services, or other tuples or information formed for the first service. The device can generate the replicas (or the count of replicas) based on combining the first service hash with one or more prime numbers (e.g., using bitwise XOR operation) selected from a prime number array. In some cases, the device may generate the replicas based on the application of the hash function (e.g., used for generating the first service hash) or a second hash function (e.g., a different hash function) to the first service hash combined with a second one or more values selected from an array (e.g., prime number array). Subsequent to generating the replicas, the device can store the replicas in the table to route requests from the client devices to access at least the first service. After generating the table, the device can proceed to ACT 708.

At ACT 708, the device can determine whether at least one service is added or removed (or becomes unavailable) from the network. For example, the device can detect or identify at least one service (or server) joining the network (e.g., became available) to provide service access to the client devices or that an existing service is removed or became unavailable. If the device detects an added or removed service, the device can proceed to ACT 710. Otherwise, the device can proceed to ACT 712.

At ACT 710, the device can update the table according to services that are added or became unavailable. For example, the device may determine that the first service of the plurality of services is unavailable. In this example, the device can remove or disable the replicas in the table generated for or associated with the first service to cause subsequent requests for the first service to be routed to a different service of the plurality of services. Removing the replicas may involve the device deleting or removing finger hash values associated with the replicas of the first service from respective indices of the table and unsetting the hash mask indices corresponding to the replicas (e.g., set to 0 to indicate that the indices are available for inserting replicas). Disabling the replicas may involve providing indicators (or markers) to indices of the table associated with the replicas of the first service, indicating that the service instances are unavailable. The hash mask indices corresponding to these replicas can remain set (e.g., still set to 1).

In another example, the device may determine that the first service is available subsequent to its removal or unavailability. In this case, the device can update the table to include or enable the replicas generated for the first service to maintain a consistent mapping of client devices to the plurality of services. The device can enable the replicas if these replicas have been previously disabled. The device can include or add the replicas associated with the first service if the replicas have been previously removed or did not exist in the table. When adding the replicas, the device can maintain the placement of indices associated with replicas of other services, such that other replicas are not affected by the addition of new replicas, for example.

At ACT 712, the device can maintain a table of the count of replicas of each of the various services (e.g., whether enabled or disabled) that are generated based on the weight of each of the services. At ACT 714, the device can select, from the table based on the request, a service of the plurality of services. For example, the device can determine an index of the table based on the request, such as IP address (e.g., source or destination IP address), port, URL, or other information associated with the client device sending the request. By using the table generated based on the weight of the services, the device can select the service that allows load balancing and distribution based on weights. At ACT 716, the device can route the request to the selected service of the plurality of services.

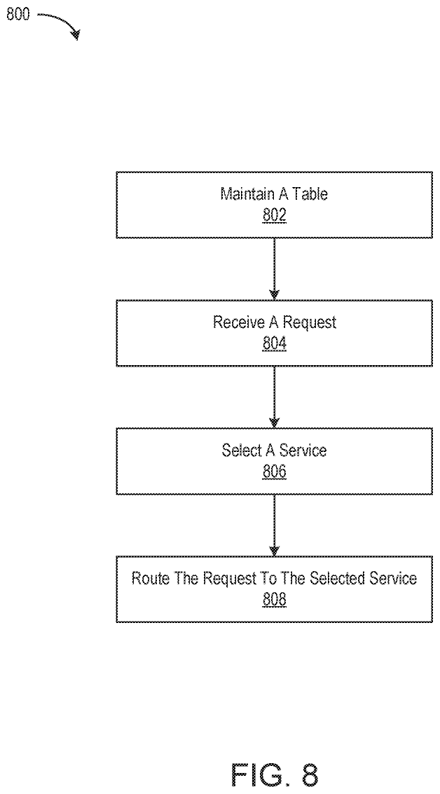

FIG. 8 depicts a flow diagram of an example method 800 for weight-based distribution for consistent hashing algorithm, in accordance with an embodiment. The example method 800 can be executed, performed, or otherwise carried out by one or more components of the system 200 (e.g., client devices 204, device 210, or servers 208), the computer 100, or any other computing devices described herein in conjunction with FIGS. 1A-B. The method 800 can include a device (e.g., a device intermediary to client devices and servers, including one or more processors, coupled with memory) maintaining a table (802). The device can receive a request (804). The device can select a service (806). The device can route the request to the selected service (808).

In further detail, at ACT 802, the device can maintain a table of a count of replicas of each of a plurality of services that is generated based on a weight of each of the plurality of services. The device can maintain, generate, update, or otherwise store the table. The count of replicas can refer to the number of replicas or quantity of replicas for each service. For example, the count or quantity of replicas for a first service can be 4, the count or quantity of replicas for a second service can be 2, and the count or quantity of replicas for a third server can be 6.

At ACT 804, the device can receive, from a client device remote from the one or more processors, a request. The request can be to access a particular server or service provided by a server. The request can be to perform a function, execute or use a network application, or execute, use, or launch a virtual machine. The request can include information, such as an internet protocol (“IP”) address of the source of the request, an IP address of the server or service for which access is being requested, a port of the server or service, or other identifiers or information used to facilitate handling a request.

At ACT 806, the device can select, from the table based on the request, a service of the plurality of services. To select the request, the device can form a tuple of information provided in the request, and then input the tuple into a hash function. At ACT 808, the device can route the request to the selected service of the plurality of services.

### FURTHER EXAMPLE EMBODIMENTS

The following examples pertain to further embodiments, from which numerous permutations and configurations will be apparent.

Example 1 includes a system, comprising: one or more processors, coupled with memory, to: maintain a table of a count of replicas of each of a plurality of services that is generated based on a weight of each of the plurality of services; receive, from a client device remote from the one or more processors, a request; select, from the table based on the request, a service of the plurality of services; and route the request to the selected service of the plurality of services.

Example 2 includes the subject matter of Example 1, wherein the one or more processors are further configured to: determine a first count of replicas for a first service of the plurality of services based on a first weight of the first service; and determine a second count of replicas for a second service of the plurality of services based on a second weight of the second service, wherein the first count of replicas is greater than the second count of replicas and the first weight is greater than the second weight.

Example 3 includes the subject matter of any one of Examples 1 and 2, wherein the first service has a greater processing capacity compared to the second service.

Example 4 includes the subject matter of any one of Examples 1 through 3, wherein the plurality of services comprises a plurality of servers.

Example 5 includes the subject matter of any one of Examples 1 through 4, wherein the plurality of services comprise a plurality of virtual machines hosted in a cloud computing environment.

Example 6 includes the subject matter of any one of Examples 1 through 5, wherein the one or more processors are further configured to: generate a first service hash based on application of a hash function to a tuple formed from an IP address and a port of a first service of the plurality of services; generate a plurality of replicas based on combining the first service hash with one or more prime numbers selected from a prime number array; and store the plurality of replicas in the table to route requests to access the first service.

Example 7 includes the subject matter of any one of Examples 1 through 6, wherein the one or more processors is further configured to: determine a first count of replicas to generate based on a replication factor for the first service; and generate the plurality of replicas with the first count of replicas.

Example 8 includes the subject matter of any one of Examples 1 through 7, wherein the one or more processors is further configured to: determine a first count of replicas to generate based on a replication factor for the first service and a first weight of the first service; and generate the plurality of replicas with the first count of replicas.

Example 9 includes the subject matter of any one of Examples 1 through 8, wherein the one or more processors is further configured to: generate a first service hash based on application of a hash function to a tuple formed for a first service of the plurality of services; generate a plurality of replicas based on application of the hash function or a second hash function to the first service hash combined with a second one or more values selected from an array; and store the plurality of replicas in the table to route requests to access the first service.

Example 10 includes the subject matter of any one of Examples 1 through 9, wherein the one or more processors is further configured to: determine that a first service of the plurality of services is unavailable; and remove or disable replicas in the table generated for the first service to cause subsequent requests for the first service to be routed to a different service of the plurality of services.

Example 11 includes the subject matter of any one of Examples 1 through 10, wherein the one or more processors is further configured to: determine subsequent to the removal, that the first service is available; and update the table to include or enable the replicas generated for the first service to maintain a consistent mapping of client devices to the plurality of services.

Example 12 includes a method, comprising: maintaining, by one or more processors coupled with memory, a table of a count of replicas of each of a plurality of services that is generated based on a weight of each of the plurality of services; receiving, by the one or more processors, a request from a client device remote from the one or more processors; selecting, by the one or more processors, from the table based on the request, a service of the plurality of services; and muting, by the one or more processors, the request to the selected service of the plurality of services.

Example 13 includes the subject matter of Example 12, comprising: determining, by the one or more processors, a first count of replicas for a first service of the plurality of services based on a first weight of the first service; and determining, by the one or more processors, a second count of replicas for a second service of the plurality of services based on a second weight of the second service, wherein the first count of replicas is greater than the second count of replicas and the first weight is greater than the second weight.

Example 14 includes the subject matter of any one of Examples 12 and 13, wherein the first service has a greater processing capacity compared to the second service.

Example 15 includes the subject matter of any one of Examples 12 through 14, comprising: generating, by the one or more processors, a first service hash based on application of a hash function to a tuple formed from an IP address and a port of a first service of the plurality of services; generating, by the one or more processors, a plurality of replicas based on combining the first service hash with one or more prime numbers selected from a prime number array; and storing, by the one or more processors, the plurality of replicas in the table to route requests to access the first service.

Example 16 includes the subject matter of any one of Examples 12 through 15, comprising: determining, by the one or more processors, a first count of replicas to generate based on a replication factor for the first service; and generating, by the one or more processors, the plurality of replicas with the first count of replicas.

Example 17 includes the subject matter of any one of Examples 12 through 16, comprising: determining, by the one or more processors, a first count of replicas to generate based on a replication factor for the first service and a first weight of the first service; and generating, by the one or more processors, the plurality of replicas with the first count of replicas.

Example 18 includes the subject matter of any one of Examples 12 through 17, comprising: generating, by the one or more processors, a first service hash based on application of a hash function to a tuple formed for a first service of the plurality of services; generating, by the one or more processors, a plurality of replicas based on application of the hash function or a second hash function to the first service hash combined with a second one or more values selected from an array; and storing, by the one or more processors, the plurality of replicas in the table to route requests to access the first service.

Example 19 includes the subject matter of any one of Examples 12 through 18, comprising: determining, by the one or more processors, that a first service of the plurality of services is unavailable; and removing, by the one or more processors from the table, replicas generated for the first service to cause subsequent requests for the first service to be routed to a different service of the plurality of services.

Example 20 includes a non-transitory computer-readable medium storing processor executable instructions that, when executed by one or more processors, cause the one or more processors to: maintain a table of a count of replicas of each of a plurality of services that is generated based on a weight of each of the plurality of services; receive, from a client device remote from the one or more processors, a request; select, from the table based on the request, a service of the plurality of services; and route the request to the selected service of the plurality of services.

Various elements, which are described herein in the context of one or more embodiments, may be provided separately or in any suitable subcombination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, USB Flash memory, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

What is claimed is:

1. A system, comprising:
one or more processors, coupled with memory, to:
maintain a table of a count of replicas of each of a plurality of services that is generated based on a weight of each of the plurality of services;
receive, from a client device remote from the one or more processors, a request;
select, from the table based on the request, a service of the plurality of services; and
route the request to the selected service of the plurality of services.

2. The system of claim 1, wherein the one or more processors are further configured to:
determine a first count of replicas for a first service of the plurality of services based on a first weight of the first service; and
determine a second count of replicas for a second service of the plurality of services based on a second weight of the second service, wherein the first count of replicas is greater than the second count of replicas and the first weight is greater than the second weight.

3. The system of claim 2, wherein the first service has a greater processing capacity compared to the second service.

4. The system of claim 1, wherein the plurality of services comprises a plurality of servers.

5. The system of claim 1, wherein the plurality of services comprise a plurality of virtual machines hosted in a cloud computing environment.

6. The system of claim 1, wherein the one or more processors are further configured to:
generate a first service hash based on application of a hash function to a tuple formed from an IP address and a port of a first service of the plurality of services;
generate a plurality of replicas based on combining the first service hash with one or more prime numbers selected from a prime number array; and
store the plurality of replicas in the table to route requests to access the first service.

7. The system of claim 6, wherein the one or more processors is further configured to:
determine a first count of replicas to generate based on a replication factor for the first service; and
generate the plurality of replicas with the first count of replicas.

8. The system of claim 6, wherein the one or more processors is further configured to:
determine a first count of replicas to generate based on a replication factor for the first service and a first weight of the first service; and
generate the plurality of replicas with the first count of replicas.

9. The system of claim 1, wherein the one or more processors is further configured to:
generate a first service hash based on application of a hash function to a tuple formed for a first service of the plurality of services;
generate a plurality of replicas based on application of the hash function or a second hash function to the first service hash combined with a second one or more values selected from an array; and
store the plurality of replicas in the table to route requests to access the first service.

10. The system of claim 1, wherein the one or more processors is further configured to:
determine that a first service of the plurality of services is unavailable; and
remove or disable replicas in the table generated for the first service to cause subsequent requests for the first service to be routed to a different service of the plurality of services.

11. The system of claim 10, wherein the one or more processors is further configured to:
determine subsequent to the removal, that the first service is available; and
update the table to include or enable the replicas generated for the first service to maintain a consistent mapping of client devices to the plurality of services.

12. A method, comprising:
maintaining, by one or more processors coupled with memory, a table of a count of replicas of each of a plurality of services that is generated based on a weight of each of the plurality of services;
receiving, by the one or more processors, a request from a client device remote from the one or more processors;
selecting, by the one or more processors, from the table based on the request, a service of the plurality of services; and
routing, by the one or more processors, the request to the selected service of the plurality of services.

13. The method of claim 12, comprising:
determining, by the one or more processors, a first count of replicas for a first service of the plurality of services based on a first weight of the first service; and
determining, by the one or more processors, a second count of replicas for a second service of the plurality of services based on a second weight of the second service, wherein the first count of replicas is greater than the second count of replicas and the first weight is greater than the second weight.

14. The method of claim 13, wherein the first service has a greater processing capacity compared to the second service.

15. The method of claim 12, comprising:
generating, by the one or more processors, a first service hash based on application of a hash function to a tuple formed from an IP address and a port of a first service of the plurality of services;
generating, by the one or more processors, a plurality of replicas based on combining the first service hash with one or more prime numbers selected from a prime number array; and
storing, by the one or more processors, the plurality of replicas in the table to route requests to access the first service.

16. The method of claim 15, comprising:
determining, by the one or more processors, a first count of replicas to generate based on a replication factor for the first service; and
generating, by the one or more processors, the plurality of replicas with the first count of replicas.

17. The method of claim 15, comprising:
determining, by the one or more processors, a first count of replicas to generate based on a replication factor for the first service and a first weight of the first service; and
generating, by the one or more processors, the plurality of replicas with the first count of replicas.

18. The method of claim 12, comprising:
generating, by the one or more processors, a first service hash based on application of a hash function to a tuple formed for a first service of the plurality of services;
generating, by the one or more processors, a plurality of replicas based on application of the hash function or a second hash function to the first service hash combined with a second one or more values selected from an array; and
storing, by the one or more processors, the plurality of replicas in the table to route requests to access the first service.

19. The method of claim 12, comprising:
determining, by the one or more processors, that a first service of the plurality of services is unavailable; and
removing, by the one or more processors from the table, replicas generated for the first service to cause subsequent requests for the first service to be routed to a different service of the plurality of services.

20. A non-transitory computer-readable medium storing processor executable instructions that, when executed by one or more processors, cause the one or more processors to:
maintain a table of a count of replicas of each of a plurality of services that is generated based on a weight of each of the plurality of services;
receive, from a client device remote from the one or more processors, a request;
select, from the table based on the request, a service of the plurality of services; and
route the request to the selected service of the plurality of services.
